(19) United States
(12) Patent Application Publication
(10) Pub. No.: US 2026/0094014 A1
(43) Pub. Date: Apr. 2, 2026

(54) Knowledgebase Platform with Interchangeable LLMs

(71) Applicant: Muneeb Khadeer, San Jose, CA (US)

(72) Inventor: Muneeb Khadeer, San Jose, CA (US)

(21) Appl. No.: 18/903,682

(22) Filed: Oct. 1, 2024

(51) Int. Cl. G06N 5/022

(52) U.S. Cl. CPC G06N 5/022

(57) ABSTRACT

A computer-implemented method for managing a knowledgebase platform involves capturing and storing inputs, outputs, and user feedback through a middle interaction layer. The platform generates valid and verified responses based on the stored data and provides these responses repeatedly. The system includes a middle interaction layer and a processing unit to manage the data and generate responses. The platform may be offered as a software service for various business applications.

### TECHNICAL FIELD

A knowledgebase platform that may capture and store interactions and inputs, provide repeatable results, and allow for interchangeable LLMs.

### BACKGROUND

Machine learning (ML) and artificial intelligence (AI) are at the forefront of technology products. The underlying models powering these products are often large-language models (LLMs) being built and improved daily by organizations worldwide. Although LLMs enable people to be more productive than before, they can develop bias, falsify information, and are not able to produce repeatable results.

### SUMMARY

A software platform may capture and store inputs, outputs, and feedback on the outputs by one or more users, generating valid and verified responses based on the stored inputs, outputs, and feedback the generated responses repeatedly. If users confirm an output, the platform may provide similar answers whenever similar inputs are provided. This may reduce a chance of incorrect outputs once an output is confirmed.

Inputs to the software platform may include user data, non-user data, manual uploads, application data, or Application Programming Interface (API) integrations.

Outputs may include text, audio, video, images, or artifacts. Feedback on the outputs by one or more users may include user satisfaction indicators, user modifications of the outputs, or user-generated outputs. The platform may generate valid and verified responses and may reinforce learning of the software platform based on the stored inputs, outputs, and feedback.

It may be provided as Software as a Service (SaaS) to businesses for communication, task management, contact management, document management, research, organization, auditing, time tracking, or querying, for example.

Management functions may be provided, which may include allowing configuration of a middle interaction layer to capture and store inputs, outputs, feedback on the outputs by users, and a processing unit configured to generate valid and verified responses based on stored inputs, outputs, and feedback, and to provide generated confirmed responses repeatedly.

### BRIEF DESCRIPTION OF THE DRAWINGS

FIG. 1 is a block diagram illustrating a software platform, according to one implementation.

FIG. 2 illustrates, in a flowchart, the process of capturing, storing, and utilizing data in a software platform according to one implementation.

FIG. 3 is a block diagram illustrating an example of a system capable of supporting Knowledgebase Platform with Interchangeable LLMs, according to one embodiment.

FIG. 4 is a component diagram of a computing device that may support Knowledgebase Platform with Interchangeable LLMs, according to one embodiment.

### DETAILED DESCRIPTION

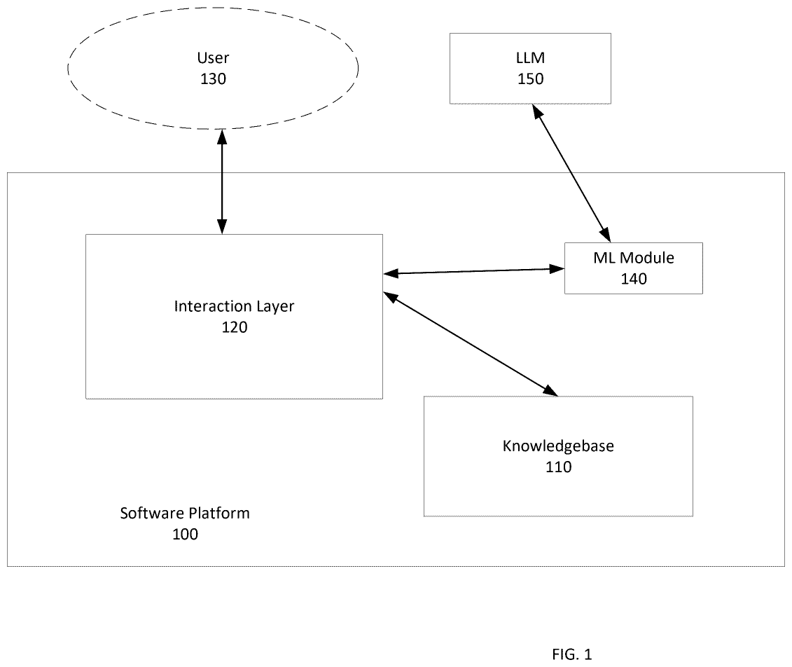

FIG. 1 is a block diagram illustrating Software Platform 100, according to one implementation.

Software Platform 100 (the system) may validate and verify outputs accepted by User 130, may ensure repeatability of results on unchanged data, and may enable the interchangeability of underlying Large Language Models (150) to leverage effective AI technologies available. Feedback mechanisms may allow actions such as sending, modifying, or deleting outputs informing the software of user satisfaction levels and guiding the generation of future responses. This feedback loop may reinforce the learning of the system's AI components, allowing for continuous improvement of output quality and relevance. Software Platform 100 may include a Knowledgebase 110 and may continue to learn and provide valid and verified responses repeatably. Knowledgebase 110 may provide storage of data and may capture interactions Software Platform 100 has with internal and external sources.

User 130 may interact with Software Platform 100 through Interaction Layer 120, which may be responsible for intercepting, tracking, and storing inputs. Inputs may include user data, non-user data, manual uploads, application data, manual uploads, other applications, and API integrations. Interaction Layer 120 may also capture and store other interactions with User 130 or Knowledgebase 110, including outputs from Knowledgebase 110 and feedback from User 130.

Software Platform 100 may create a validation and verification stamp on system output accepted by User 130, which may provide repeatable results on unchanged data and enable interchangeability of underlying language models.

Software Platform 100 may learn and evolve, using Machine Learning (ML) Module 140. ML Module 140 may interact with Large Language Model 150, which may be selected to work well for the business goals of the system, and may be selected for particular tasks or goals of the business, which may vary over time.

Machine Learning (ML) is a subset of artificial intelligence (AI) focused on developing algorithms and statistical models that enable computer systems to perform specific tasks without explicit instructions. These systems learn from data by identifying patterns and making decisions based on statistical analysis, improving their performance over time as they are exposed to more data. ML encompasses a variety of techniques, including supervised learning, where models are trained on labeled datasets; unsupervised learning, where models identify patterns in unlabelled data; and reinforcement learning, where models learn to make decisions through trial and error by receiving rewards or penalties. ML is employed in a wide range of applications, such as natural language processing, image recognition, and predictive analytics, where its ability to adapt and improve from experience makes it a powerful tool for automating and enhancing complex processes.

Large Language Models (LLMs) are a specialized type of machine learning model designed to understand, generate, and manipulate human language. These models are typically based on deep learning architectures, such as transformer networks, which are particularly well-suited for processing sequential data like text. LLMs are trained on vast datasets containing diverse linguistic content, enabling them to learn the nuanced patterns and structures of language. As a result, they can perform a wide array of tasks, including text generation, translation, summarization, and sentiment analysis, with remarkable accuracy and fluency. The development of LLMs has significantly advanced the field of natural language processing (NLP), providing robust tools for automating text-based tasks, improving human-computer interaction, and supporting advanced research in linguistics and AI-driven communication.

This may allow the system to offer valid and verified responses based on the inputs and feedback provided by User 130, as well as other inputs. Its design may facilitate a wide range of business applications, including communication, task management, contact management, document management, research, organization, auditing, time tracking, and querying, which may unlock new efficiencies by integrating people, processes, and technology. Software Platform 100 may provide a knowledge management solution that captures comprehensive data and interactions, applies rigorous validation and verification processes, and utilizes advanced AI to generate reliable and repeatable responses. This approach may not only enhance the effectiveness of Software Platform 100 but may also ensure its adaptability and relevance in the face of evolving AI technologies and business needs. It may also allow User 130 to select a different LLM depending on the current goal.

The ability to select between various Large Language Models (LLMs) depending on specific tasks or objectives may provide significant technical advantages, particularly with respect to optimizing system performance and resource utilization. Different LLMs may be trained on distinct datasets, fine-tuned for particular domains, or designed to prioritize different aspects of language processing, such as accuracy, contextual relevance, computational efficiency, or execution speed. For example, a general-purpose LLM trained on diverse and broad datasets may be more suitable for open-ended text generation or conversational tasks, while a smaller, domain-specific model could be more efficient for tasks requiring specialized knowledge, such as legal document analysis or technical translations. By allowing for the selection of the most appropriate LLM based on task-specific requirements, the system can more effectively balance trade-offs between model complexity, resource consumption, and task demands.

Moreover, the ability to select from different LLMs tailored to particular domains or applications can enhance the precision and relevance of output in specialized fields. For instance, an LLM trained on medical literature may perform better in generating or interpreting clinical documents than a general-purpose model, which may lack sufficient knowledge of domain-specific terminology and concepts. Similarly, an LLM specifically optimized for software code generation may outperform a general model in tasks involving software development or source code analysis. This flexibility in selecting between various LLMs provides a technical benefit of optimizing performance of machine learning models in a targeted manner, depending on a task or goal at hand, which may lead to more efficient, accurate, and context-appropriate results.

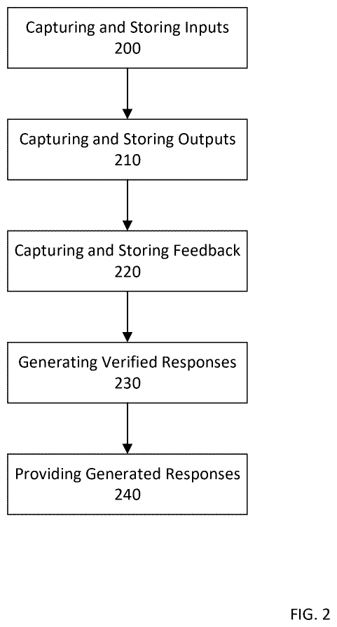

FIG. 2 illustrates, in a flowchart, the process of Capturing and Storing Inputs 200, according to one implementation. Inputs may include API integrations, email, calendar events or meetings, Microsoft Teams™ data, Slack™ data, Twilio™ data, WhatsApp™ messages, text messages, or other software data, for example.

Capturing and Storing Outputs 210 may record output interactions between the system and User 130 and other users. Capturing and Storing Feedback 220 may record feedback provided by one or more Users 130. Tracking feedback may assist the Software Platform 100 in improving future outputs based on these interactions. The entities involved in this step may include the middle interaction layer, Knowledgebase 140, and one or more users. Interaction Layer 120 may capture and store feedback, which may assist in data collection. Knowledgebase 140 may utilize this feedback to enhance its learning and response generation capabilities.

The actions associated with these entities may include capturing and tracking actions by individuals and the system and capturing interactions between User 130 and the system. This comprehensive interaction capture mechanism may ensure the system can monitor and record user interactions effectively. The feedback mechanisms may include user satisfaction indicators, user modifications to the outputs, and user-generated outputs. These feedback types may assist with auditing, compliance, and user interaction tracking.

The feedback process may include capturing every interaction between User 130 and the system, which may include user input provided to the system, output from the system to User 130, User's 130 interaction with the output, and the system's ability to capture the interaction and improve future outputs based on user inputs. The system also captures and stores every non-user input into the system, including data coming through manual uploads, other applications, and API integrations. This may include Generating Verified Responses 230, which may provide the same outputs when given the same inputs.

Interaction Layer 120 may Capture and Store Outputs 210 from Knowledgebase 110. This step may involve several entities, including, for example, user input, Slack APIs, application interfaces (APIs), Gmail APIs, Twilio APIs, interaction, other inputs, and Microsoft Outlook APIs, for example.

Interaction Layer 120 may intercept, track, and store interactions between User 130 and Software Platform 100. This may include user input, output from Knowledgebase 110, User's 130 interaction with the output, and Software Platform's 100 ability to capture the interaction and improve future outputs based on future user inputs. The Software Platform 100 may also capture and store non-user input, which may include both user and non-user data coming into the system through manual uploads, other applications, and API integrations.

The architecture of the platform may capture and store every interaction between User 130 and Software Platform 100. This may include both user and non-user data coming through manual uploads, other applications, and API integrations, user input provided to the system, the output from the system to User 130, User's 130 interaction with output, and the ability to capture the interaction and improve future outputs based on future user inputs.

Software Platform 100 may continue to learn and provide valid and verified responses repeatably. It may do this by using Interaction Layer 120 between User 130 and ML Module 140. Interaction Layer 120 may intercept, track, and store inputs into the software platform by the software itself. This may include data coming into the platform through its usage of application interfaces (APIs) such as Microsoft Outlook APIs (Email, Calendar, Teams), Gmail APIs, Slack APIs, and Twilio APIs (WhatsApp, Text Message, etc.).

Input into the system by User 130 using Software Platform 100 may include responses to communication such as email, text messages, audio, video, image, and emojis, as well as artifacts uploaded by the individual such as text documents, audio, video, and image files. Output of the platform presented to a specific individual or a set of individuals may include text, audio, video, and images and artifacts such as text documents, audio, video, and image files.

Feedback by an individual or set of individuals on an output the software platform presented to them may be collected through various mechanisms. For example, if User 130 sends the output to another individual, this action may inform Software Platform 100 that they are satisfied with the output and have validated and verified it. The next time the same action is performed, or the same input is provided to the system, the system may provide the same output. Running reports, compliance checks, audit trails, and any export may place a watermark on all the outputs that individuals send to other individuals. This watermark may inform individuals outside the software ecosystem that the data comes from within Software Platform 100 and not through a random system.

If User 130 modifies output before sending it to another individual, this may inform Software Platform 100 that they may not be fully satisfied with the output presented to them. The output they desired from the system may be what they modified the original output to before sending it to another individual. The next time the same action is performed, or the same input is provided to the system, the software system may provide the user-modified output.

If User 130 deletes the output and rewrites it before sending it to another individual, this may inform the system that they are not at all satisfied with the output that Software Platform 100 presented to them. The output they desired from the system may be what they modified the original output to before sending it to another individual. The next time the same action is performed, or the same input is provided to the system, the software system may provide the user-generated output. Running reports, compliance checks, audit trails, and any export will place a watermark on all the outputs that individuals send to other individuals. This watermark may inform individuals outside the software ecosystem that the data comes from within Software Platform 100 and not through a random system.

The LLM system API used by the software system to generate the original output may also be reinforced with information that the output provided was satisfactory or not satisfactory. This may be similar to a user in ChatGPT giving a thumbs up or thumbs down to the response provided by ChatGPT. The user-modified output may be the prompt response/feedback to the LLM system for training. Software Platform 100 may be designed to include proprietary and secure Knowledgebase 110 that continues to learn and repeatedly provides valid and verified responses. It may include Interaction Layer 120 between User 130 in the loop and ML Module 140 to intercept, track, and store inputs and outputs. Interaction Layer 120 may ensure that every input into the platform by the software itself, including data from application interfaces (APIs) such as Microsoft Outlook APIs, email, calendar, and Teams, for example, Gmail APIs, Slack APIs, and Twilio APIs, WhatsApp, and Text Message, is captured and stored.

The data collected and stored within Software Platform 100 may enable it to be LLM-independent. They may introduce a level of validity, verification, and repeatability that may not exist with other systems. The same stored data can also be used to train new and improved LLMs, which may unlock additional value for businesses over time.

Overall, Software Platform 100 may ensure that Knowledgebase 140 continues to learn and provide valid and verified responses repeatably, enhancing the reliability and accuracy of the system's outputs.

Generating Verified Responses 230 by the Knowledgebase 140 may involve reinforcing the platform's learning based on the stored inputs, outputs, and feedback. Knowledgebase 140 may be designed to continue learning and providing valid and verified responses repeatably. This may be achieved through Interaction Layer 120, which may intercept, track, and store every input into Software Platform 100 by the software itself. This may include data coming into the platform through its usage of application interfaces (APIs) such as Microsoft Outlook APIs (Email, Calendar, Teams), Gmail APIs, Slack APIs, and Twilio APIs (WhatsApp, Text Message, etc.).

Capturing and Storing Feedback 220 may capture every input into the system by User 130, including individual responses to communication such as email, text message, audio, video, image, and emojis, as well as artifacts uploaded by the individual such as text documents, audio, video, and image files. Every output of the platform presented to a specific individual or a set of individuals may also be captured, including text, audio, video, images, and artifacts such as text documents, audio, video, and image files.

Software Platform 100 may be used as Software as a Service (SaaS) and may provide a comprehensive suite of services that enhances how businesses communicate, manage tasks, contacts, documents, conduct research, and organize around specified business focus areas. It may enable seamless internal and external communications through integration with various email APIs, such as those provided by Microsoft Outlook and Google Gmail. It may facilitate direct conversations for users lacking email access. It may prioritize conversations based on participants before subject matter, thereby organizing email threads more intuitively in either a Time-View, showing real-time communications, or a Subject-View, aggregating messages within a subject for streamlined review.

Utilizing communication threads, Software Platform 100 may automate creation and updating of tasks, send reminders for upcoming deadlines, recognize finished tasks, and maintain a comprehensive schedule to ensure critical deadlines and deliverables are met.

Software Platform 100 may intelligently create contact entries by analyzing communication threads, recognizing mentioned individuals, and integrating with company Single-Sign-On or email credentials for internal contacts. It may allow detailed management of external contacts, including audit trails for changes, and enable internal users to view and update their contact information, facilitating a robust network of connections.

Software Platform 100 may support the generation, secure sharing, and organization of documents across various formats, including text, audio, video, and images. It may categorize documents by business focus area and type, allowing users to upload specific documents as needed manually.

Software Platform 100 may offer specialized tools for conducting research within specific business focus areas, tracking time spent, content referenced, and contributors to the research. This feature supports a wide range of disciplines, including legal research, patent searches, healthcare information, and more.

Software Platform 100 may enable users to center their workflow around crucial business focus areas, organizing communications, tasks, documents, and research accordingly to efficiently manage matters, patents, accounts, projects, issues, and patient information.

Software Platform 100 may comprehensively track all user and system actions to facilitate training, compliance checks, audit trails, report generation, and billing processes, leveraging the data to improve system functionality and integrity.

Software Platform 100 may also capture detailed logs of time spent by users on various activities within the system, which may be important for compliance, reporting, invoicing, and optimizing workflows.

While LLMs may enhance the platform's capabilities, challenges such as bias and repeatability may need to be managed. To this end, Software Platform 100 may incorporate mechanisms for regular assessment and calibration of LLM outputs, ensuring the reliability and integrity of the system. This may include engagement with external efficacy benchmarks, such as those provided by Stanford University's CRFM (https://crfm.stanford.edu/helm/lite/latest/#/leaderboard), to continually evaluate and improve the platform's performance and productivity impact.

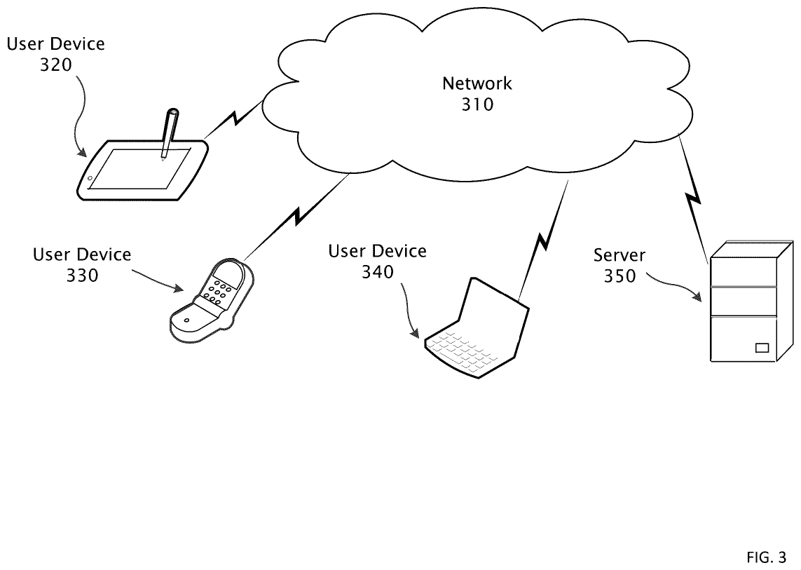

FIG. 3 is a block diagram illustrating an example of a system capable of supporting Knowledgebase Platform with Interchangeable LLMs, according to one embodiment.

Network 310 may include Wi-Fi, cellular data access methods, such as 3G, 4GLTE, or 5G, Bluetooth, Near Field Communications (NFC), the internet, local area networks, wide area networks, or any combination of these or other means of providing data transfer capabilities. In one implementation, Network 310 may comprise Ethernet connectivity. In another implementation, Network 310 may comprise fiber optic connections.

User Device 320, 330, or 340 may have network capabilities to communicate with Server 350. Server 350 may include one or more computers and may serve several roles. Server 350 may be conventionally constructed or may be of a special purpose design for processing data obtained from Knowledgebase Platform with Interchangeable LLMs. One skilled in the art will recognize that Server 350 may have many different designs and capabilities.

User Device 320, 330, or 340 may be used by lawyers, for example, by accessing a website or executing an app. Server 350 may store and provide legal information, such as cases, and may be used to host a website, allow reviewing cases, or perform other tasks. One skill in the art will recognize that various configurations for User Device 320, 330, or 340 and Server 350 may be used to implement Knowledgebase Platform with Interchangeable LLMs.

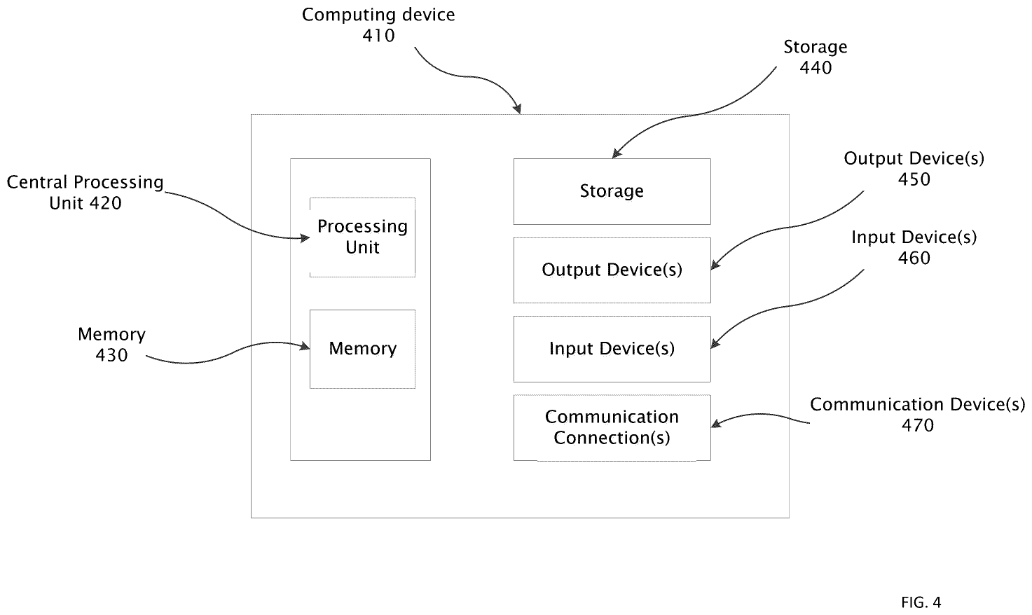

FIG. 4 is a component diagram of a computing device that may support Knowledgebase Platform with Interchangeable LLMs, according to one embodiment.

Computing Device 410 may be utilized to implement one or more computing devices, computer processes, or software modules described herein, including, for example, but not limited to, a mobile device, a server, a desktop computer, or other form factor. In one example, Computing Device 410 may process calculations, execute instructions, and receive and transmit digital signals. Computing Device 410 can be any general or special purpose computer now known or to become known capable of performing the steps or functions described herein, either in software, hardware, firmware, or a combination thereof.

Computing Device 410 typically includes at least one Central Processing Unit (CPU) 420 and Memory 430 in its most basic configuration. Depending on the exact configuration and type of Computing Device 410, Memory 430 may be volatile (such as RAM), non-volatile (such as ROM, flash memory, etc.), or some combination of the two. Additionally, Computing Device 410 may also have additional features/functionality. For example, Computing Device 410 may include multiple CPUs. The described methods may be executed in any manner by any processing unit in Computing Device 410. For example, two CPUs may execute the described process in parallel.

Computing Device 410 may also include additional storage (removable or non-removable), including, but not limited to, magnetic or optical disks or tape. Such additional storage is illustrated by Storage 440. Computer-readable storage media includes volatile and non-volatile, removable, and non-removable media implemented in any method or technology for storing information, such as computer-readable instructions, data structures, program modules, or other data. Memory 430 and Storage 440 are all examples of computer-readable storage media. Computer-readable storage media includes but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by Computing Device 410. Any such computer-readable storage media may be part of Computing Device 410. But, computer-readable storage media does not include transient signals.

Computing Device 410 may also contain Communications Device(s) 470, which allows the device to communicate with other devices. Communications Device(s) 470 is an example of communication media. Communication media typically embodies computer-readable instructions, data structures, program modules, or other data in a modulated data signal such as a carrier wave or other transport mechanism, and it includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. The term computer-readable media, as used herein, includes both computer-readable storage media and communication media. The described methods may be encoded in any computer-readable media in any form, such as data, computer-executable instructions, and the like.

Computing Device 410 may also have Input Device(s) 460, such as a keyboard, mouse, pen, voice input device, touch input device, etc. Output Device(s) 450, such as a display, speakers, printer, etc., may also be included. All these devices are well-known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed or execute some software instructions at the local terminal and some at the remote computer (or computer network). Those skilled in the art will also realize that by utilizing conventional techniques known to those skilled in the art, all or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described implementations may be made without departing from the spirit and scope of the invention.

The illustrated operations in the description also show events occurring in a particular order. In alternative implementations, certain operations may be performed in a different order, modified or removed. Moreover, steps may be added to the above-described logic and still conform to the described implementations. Further, operations described herein may occur sequentially, or certain operations may be processed in parallel. Yet further operations may be performed by a single processing unit or by distributed processing units.

1. A computer-implemented method for managing a knowledgebase platform, the method comprising:
capturing and storing, by a middle interaction layer of the knowledgebase platform, inputs into the knowledgebase platform;
capturing and storing, by the middle interaction layer, outputs presented by the knowledgebase platform;
capturing and storing, by the middle interaction layer, feedback on the outputs by one or more users;
generating, by the knowledgebase platform, valid and verified responses based on the stored inputs, outputs, and feedback; and
providing, by the knowledgebase platform, the generated responses repeatedly.

2. The method of claim 1, wherein the knowledgebase platform comprises a proprietary and secure architecture centered around a set of principles.

3. The method of claim 2, wherein the set of principles comprises:
capturing and storing user and non-user data inputs;
capturing user interactions with the knowledgebase platform;
validating and verifying outputs accepted by users;
providing repeatable results on unchanged data; and
enabling interchangeability of underlying language models.

4. The method of claim 1, wherein the inputs comprise at least one of user data, non-user data, manual uploads, application data, and API integrations.

5. The method of claim 1, wherein the outputs comprise at least one of text, audio, video, images, and artifacts.

6. The method of claim 1, wherein the feedback comprises at least one of user satisfaction indicators, user modifications to the outputs, and user-generated outputs.

7. The method of claim 1, wherein generating the valid and verified responses comprises reinforcing learning of the knowledgebase platform based on the stored inputs, outputs, and feedback.

8. The method of claim 1, further comprising providing the knowledgebase platform as a software service to businesses for communication, task management, contact management, document management, research, organization, auditing, time tracking, and querying.

9. A system for managing a knowledgebase platform, the system comprising:
a middle interaction layer configured to capture and store inputs into the knowledgebase platform, outputs presented by the knowledgebase platform, and feedback on the outputs by one or more users; and
a processing unit configured to generate valid and verified responses based on the stored inputs, outputs, and feedback, and to provide the generated responses repeatedly.

10. The system of claim 9, wherein the knowledgebase platform comprises a proprietary and secure architecture centered around a set of principles.

11. The system of claim 10, wherein the set of principles comprises:
capturing and storing user and non-user data inputs;
capturing user interactions with the knowledgebase platform;
validating and verifying outputs accepted by users;
providing repeatable results on unchanged data; and
enabling interchangeability of underlying language models.

12. The system of claim 9, wherein the inputs comprise at least one of user data, non-user data, manual uploads, application data, and API integrations.

13. The system of claim 9, wherein the outputs comprise at least one of text, audio, video, images, and artifacts.

14. The system of claim 9, wherein the feedback comprises at least one of user satisfaction indicators, user modifications to the outputs, and user-generated outputs.

15. The system of claim 9, wherein generating the valid and verified responses comprises reinforcing learning of the knowledgebase platform based on the stored inputs, outputs, and feedback.

16. The system of claim 9, wherein the processing unit is further configured to provide the knowledgebase platform as a software service to businesses for communication, task management, contact management, document management, research, organization, auditing, time tracking, and querying.

17. A non-transitory computer-readable medium storing instructions that, when executed by a processor, cause the processor to perform a method for managing a knowledgebase platform, the method comprising:
capturing and storing, by a middle interaction layer of the knowledgebase platform, inputs into the knowledgebase platform;
capturing and storing, by the middle interaction layer, outputs presented by the knowledgebase platform;
capturing and storing, by the middle interaction layer, feedback on the outputs by one or more users;
generating, by the knowledgebase platform, valid and verified responses based on the stored inputs, outputs, and feedback; and
providing, by the knowledgebase platform, the generated responses repeatedly.

18. The non-transitory computer-readable medium of claim 17, wherein the knowledgebase platform comprises a proprietary and secure architecture centered around a set of principles.

19. The non-transitory computer-readable medium of claim 18, wherein the set of principles comprises:
capturing and storing user and non-user data inputs;
capturing user interactions with the knowledgebase platform;
validating and verifying outputs accepted by users;
providing repeatable results on unchanged data; and
enabling interchangeability of underlying language models.

20. The non-transitory computer-readable medium of claim 17, wherein generating the valid and verified responses comprises reinforcing learning of the knowledgebase platform based on the stored inputs, outputs, and feedback.
